(19) United States
(12) Patent Application Publication
(10) Pub. No.: US 2014/0376887 A1
(43) Pub. Date: Dec. 25, 2014

(54) MOBILE DEVICE VIDEO SELECTION AND EDIT

(71) Applicant: Adobe Systems Incorporated, San Jose, CA (US)

(72) Inventors: Remon Tijssen, Mill Valley, CA (US); Justin E. Cole, Seattle, WA (US)

(21) Appl. No.: 13/925,648

(22) Filed: Jun. 24, 2013

(51) Int. Cl. H04N 5/232; G11B 27/031; G11B 27/34

(52) U.S. Cl. CPC H04N 5/23229; G11B 27/34; G11B 27/031
USPC 386/282

(57) ABSTRACT

In embodiments of mobile device video selection and edit, a mobile device includes an integrated digital camera that records video clips, and implements a video service that interfaces with the digital camera. A video capture user interface can be displayed that includes a selectable control to mark a video segment of a video clip while the video clip is being recorded or played back for viewing. A video select user interface can display portions of the video clips in a grid format with marked video segments identified by video segment selectors, which can be selected to increase or decrease the length of a marked video segment. A video arrange user interface can then display a list view of the marked video segments, as well as a shareable video compilation of the marked video segments.

### BACKGROUND

Many types of devices today include a digital camera that can be used to capture digital photos as well as video clips, such as with a mobile phone, tablet device, a digital camera, and other electronic media devices. The accessibility and ease of use of the many types of devices that include a digital camera makes it quite easy for anyone to take photos and record video clips almost anywhere. Although it is easy for a user to record multiple video clips, it is generally difficult to transfer video, such as from a mobile phone to a desktop device where the video can be reviewed, edited, and then shared with others. Multiple video clips can also be time consuming to go back through and review to locate the interesting segments that the user may want to keep and/or share. It can also be difficult for user to select only the sections of a video clip to keep and/or share on a mobile device. For example, a parent may follow a toddler around taking video waiting for the child to do something that the user is hoping to capture on video. Similarly, a user may record video of a sporting event hoping to capture an eventful moment. The user may then end up with several minutes of unwanted video before the event is captured, and the user will want to share the video of the event without the beginning several minutes of extra video.

### SUMMARY

This Summary introduces features and concepts of mobile device video selection and edit, which is further described below in the Detailed Description and/or shown in the Figures. This Summary should not be considered to describe essential features of the claimed subject matter, nor used to determine or limit the scope of the claimed subject matter.

Mobile device video selection and edit is described. In embodiments, a mobile device, such as a mobile phone or tablet device, includes an integrated digital camera that records video clips, and implements a video service that interfaces with the digital camera. A video capture user interface can be displayed that includes a selectable control to mark a video segment of a video clip while the video clip is being recorded or played back for viewing. A video select user interface can display portions of the video clips in a grid format with marked video segments identified by video segment selectors, which can be selected to increase or decrease the length of a marked video segment. A video arrange user interface can then display a list view of the marked video segments, as well as a shareable video compilation of the marked video segments.

### BRIEF DESCRIPTION OF THE DRAWINGS

Embodiments of mobile device video selection and edit are described with reference to the following Figures. The same numbers may be used throughout to reference like features and components that are shown in the Figures:

FIG. 1 illustrates an example mobile device system in which embodiments of mobile device video selection and edit can be implemented.

FIG. 2 illustrates an example video capture user interface in embodiments of mobile device video selection and edit.

FIG. 3 illustrates an example video select user interface in embodiments of mobile device video selection and edit.

FIG. 4 illustrates an example video arrange user interface in embodiments of mobile device video selection and edit.

FIG. 5 illustrates example method(s) of mobile device video selection and edit in accordance with one or more embodiments.

FIG. 6 illustrates example method(s) of mobile device video selection and edit in accordance with one or more embodiments.

FIG. 7 illustrates an example system with an example device that can implement embodiments of mobile device video selection and edit.

### DETAILED DESCRIPTION

Embodiments of mobile device video selection and edit are described, and may be implemented with any type of electronic and/or computing device that includes a digital camera used to record video, such as such as any type of mobile phone, tablet device, a camera device, and other electronic media devices. Typically, the best time to identify when something happens in a video that a user may want to keep and/or share is just after having recorded a particular video clip. Rather than having to keep track with a pen and paper when something interesting happens in a video, so that the user can go back and review the identified video segment, the user can now easily identify the moment that something happens during the video. In implementations, the user can identify a moment that something happens during a video while still recording the video, or after when the video is played back for review.

In embodiments, a video service is implemented on a mobile device, and the video service interfaces with a digital camera of the device. The video service includes various video user interfaces that can be displayed on a display device of the mobile device. A video capture user interface can be displayed and includes a selectable control to mark a video segment of a video clip while the video clip is being recorded or played back for viewing. A video select user interface can display portions of the video clips in a grid format with marked video segments identified by video segment selectors, and the video segment selectors can be selected to increase or decrease the length of a marked video segment. A video arrange user interface can then display a list view of the marked video segments, as well as a shareable video compilation of the marked video segments. A user can then share the marked video segments of the shareable video compilation together as one video.

While features and concepts of mobile device video selection and edit can be implemented in any number of different devices, systems, environments, and/or configurations, embodiments of mobile device video selection and edit are described in the context of the following example devices, systems, and methods.

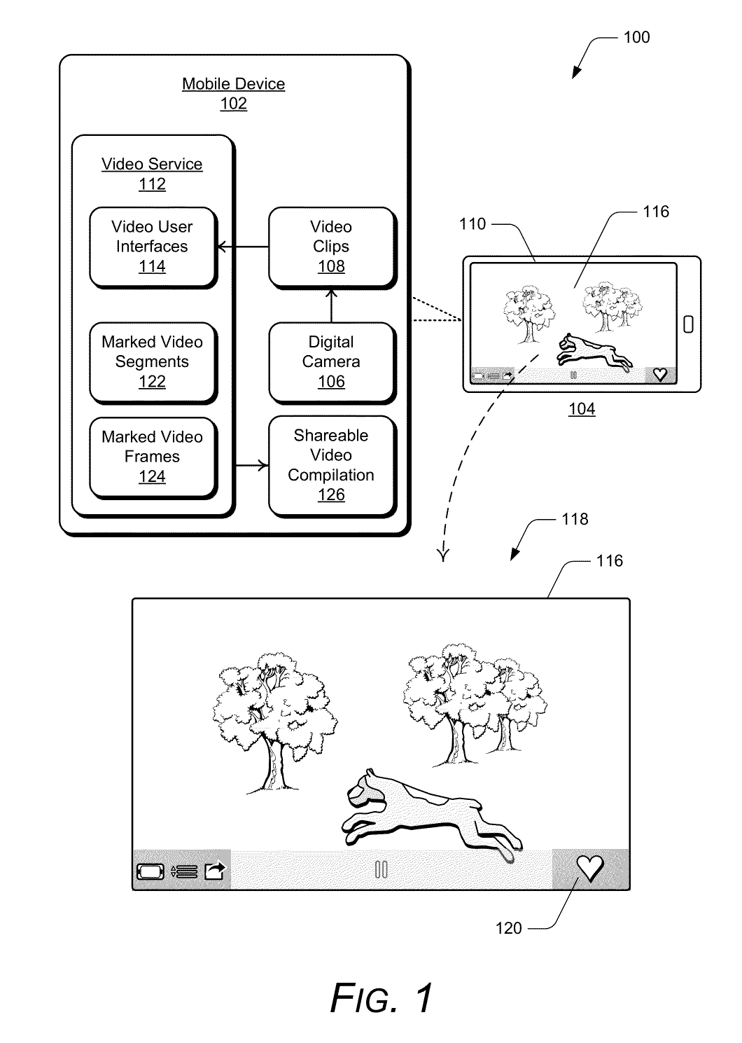

FIG. 1 illustrates an example 100 of mobile device video selection and edit in accordance with one or more embodiments. The example 100 includes a mobile device 102, such as a mobile phone 104, a camera device, a tablet device, or any other electronic media device that includes an integrated digital camera 106. A user of the mobile device can capture images (e.g., photos) and record video clips 108 with the digital camera of the device. The video clips described herein are digital video of consecutive digital images or frames recorded with the digital camera 106 that is integrated with the mobile device. A mobile device, such as the mobile phone 104, includes an integrated display device 110 to display the video clips, such as while a video clip is being recorded or played back for review. The integrated display device 110 of the mobile phone 104, or any other mobile device 102 described herein, may be implemented as a touchscreen display that detects user touch inputs and gestures.

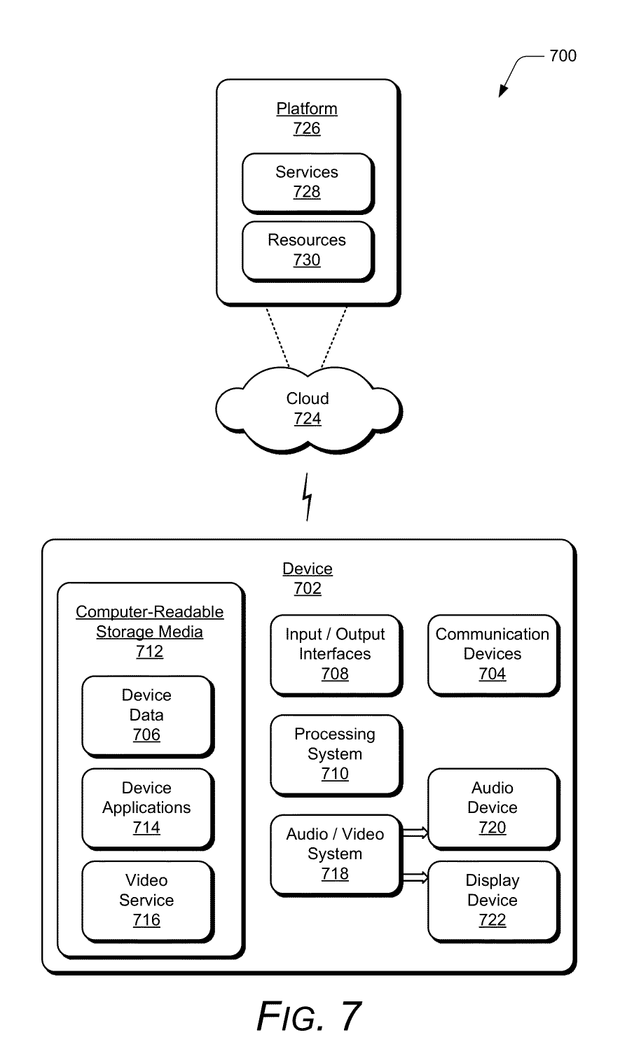

The mobile device 102 includes a video service 112 that can be implemented as a software application (e.g., executable instructions) stored on computer-readable storage media, such as any suitable memory device or electronic data storage. Additionally, the video service can be executed with a processing system of the mobile device to implement embodiments of mobile device video selection and edit. Any of the devices described herein, such as the mobile device 102 and the mobile phone 104, can be implemented with various components, such as a processing system and memory, as well as any number and combination of differing components as further described with reference to the example device shown in FIG. 7.

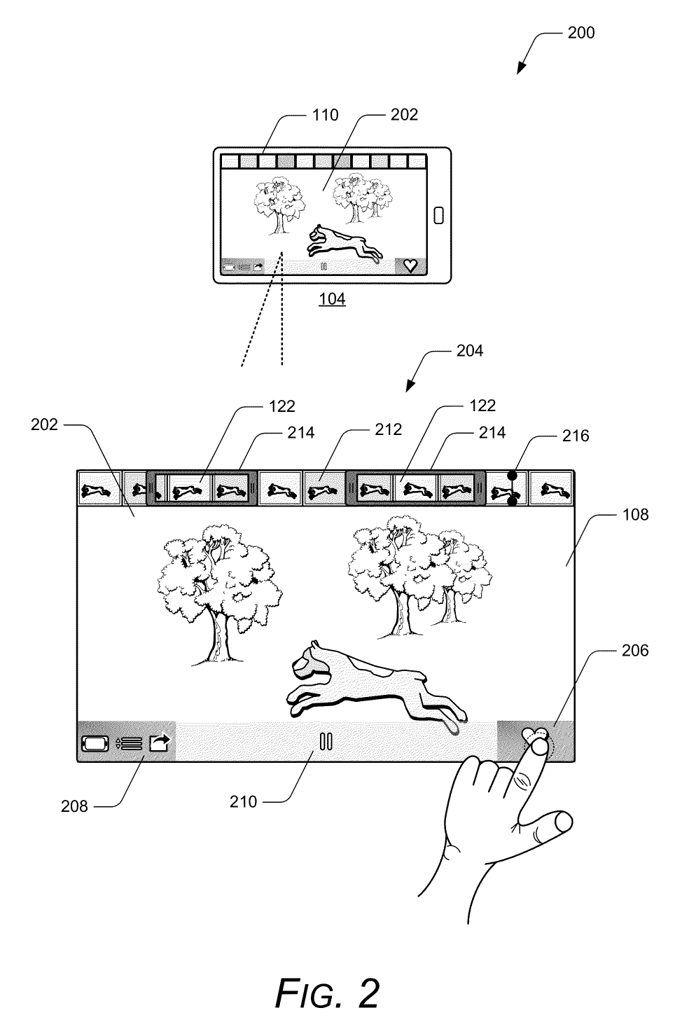

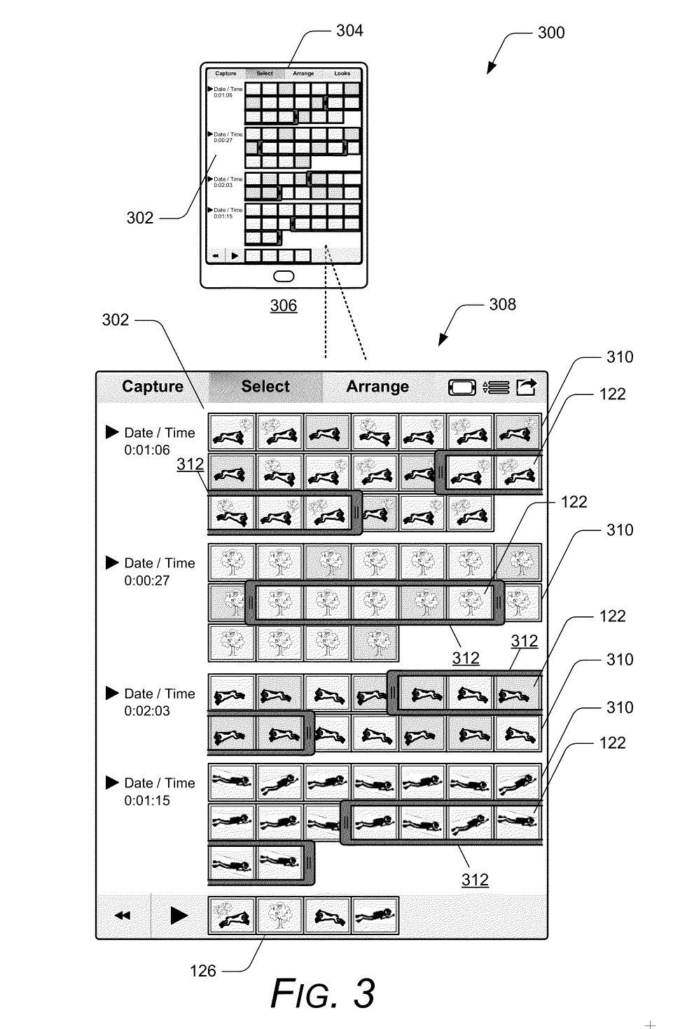

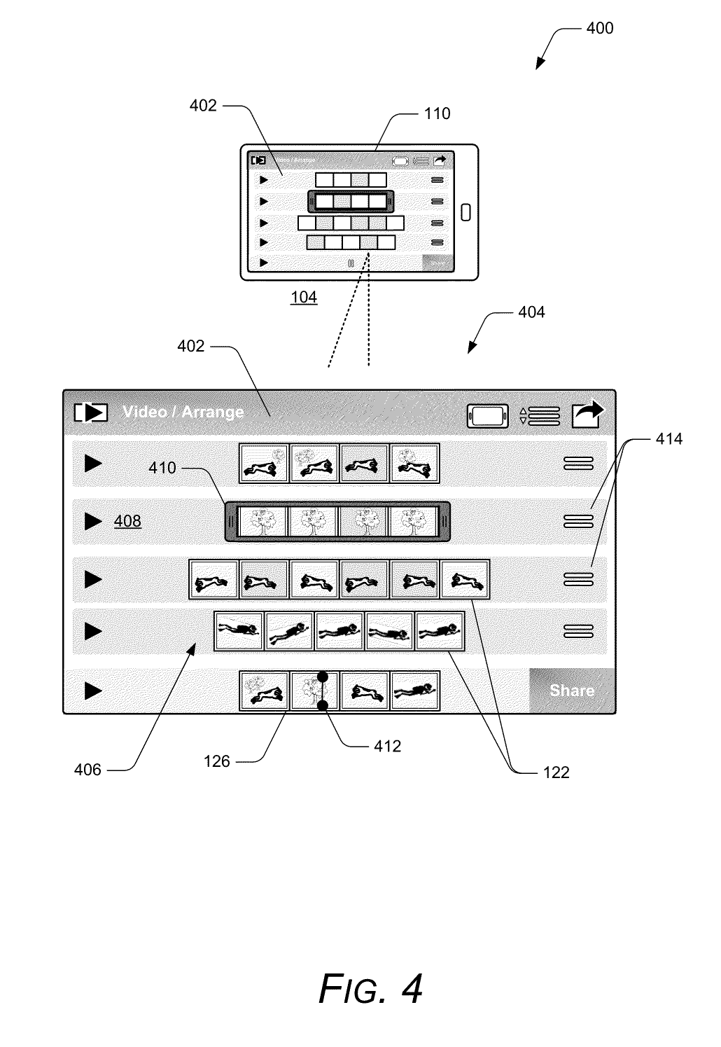

In this example, the video service 112 includes various video user interfaces 114 that can be displayed on a display device of the mobile device 102, such as on the integrated display device 110 of the mobile phone 104. The video user interfaces 114 include a video capture user interface 116 (shown larger at 118), as well as an additional video capture user interface described with reference to FIG. 2, a video select user interface described with reference to FIG. 3, and a video arrange user interface described with reference to FIG. 4.

The video capture user interface 116 can be displayed, such as on the integrated display device 110 of the mobile phone 104 when a user is recording a video clip 108. The video capture user interface 116 includes a selectable control 120 that the user can select, such as with a touch input on the display, to mark the video clip while the video clip is recording. The video service 112 is implemented to receive an input of the selectable control 120 on the video capture user interface, and then capture, or otherwise identify, a marked video segment 122 of the video clip 108 when the user marks the video clip. A marked video segment 122 of a video clip 108 can include one or more marked video frames 124 of the video clip. Alternatively, a user may just tap the display screen of the mobile device to mark a video frame and/or a video segment of the video clip that is being recorded, and the video service 112 is implemented to mark the video clip responsive to the tap on the display screen. A marked video segment is displayable independent from a video clip that is being recorded, and also displayable independent from one or more additional video segments that are captured from the same video clip.

In implementations, a user input of the selectable control 120 can be received by the video service 112 to mark video frames 124 of a video clip 108. For example, a user input of the selectable control 120 can be initiated to mark a start frame of a video segment of a video clip, and an additional input of the selectable control is received to mark an end frame of the video segment of the video clip. Alternatively, a user input of the selectable control 120 can be initiated to mark a frame of a video segment of a video clip, as well as additional frames before and/or after the marked video frame 124 that are included as part of a marked video segment 122. Alternatively, a user input of the selectable control 120 is received as a press-and-hold input on the video capture user interface 116. A start frame of a marked video segment 122 of the video clip can be marked corresponding to when the press-and-hold input is initiated, and an end frame of the marked video segment is marked responsive to the press-and-hold input being released.

In embodiments, the video service 112 is implemented to combine some or all of the marked video segments 122 to generate a shareable video compilation 126 from the marked video segments of the video clips 108. For example, the shareable video compilation 126 can be generated from several different marked video segments 122, and then shared with other users, such as when communicated or distributed to other devices that are associated with the other users. The shareable video compilation 126 can be received at a user device and played back for viewing as a compilation of the marked video segments.

FIG. 2 illustrates an example 200 of another video capture user interface 202 in embodiments of mobile device video selection and edit. The video capture user interface 202 is shown displayed on the integrated display device 110 of the mobile phone 104, and shown larger at 204. The video capture user interface 202 can be displayed on the mobile device, such as when a user is playing back a video clip 108 for review. The video capture user interface 202 includes a selectable control 206 that the user can select, such as with a touch input on the display, to mark the video clip while playing back the video clip for review. The video service 112 is implemented to receive an input of the selectable control 206 on the video capture user interface 202, and then capture, or otherwise identify, a marked video segment 122 of the video clip 108 when the user marks the video clip. Alternatively, a user may just tap the display screen of the mobile device to mark a video frame and/or a video segment of the video clip that is being played back for review, and the video service 112 is implemented to mark the video clip responsive to the tap on the display screen.

As described with reference to the video capture user interface 116 shown in FIG. 1, a user input of the selectable control 206 on the video capture user interface 202 can be received by the video service 112 to mark video frames 124 of a video clip 108 that is played back for review. For example, a user input of the selectable control 206 can be initiated to mark a start frame of a video segment of a video clip, and an additional input of the selectable control is received to mark an end frame of the video segment of the video clip. Alternatively, a user input of the selectable control 206 can be initiated to mark a frame of a video segment of a video clip, as well as additional frames before and/or after the marked video frame 124 that are included as part of a marked video segment 122. Alternatively, a user input of the selectable control 206 is received as a press-and-hold input on the video capture user interface 202. A start frame of a marked video segment 122 of the video clip is marked corresponding to the press input, and an end frame of the marked video segment is marked responsive to the press-and-hold input being released.

In this example, the video capture user interface 202 includes other selectable controls 208, such as to initiate the video select user interface described with reference to FIG. 3 or the video arrange user interface described with reference to FIG. 4. The selectable controls 208 can also be utilized to initiate sharing the shareable video compilation 126 to other user devices. The video capture user interface 202 can also include video playback selectable controls, such as a combination stop, pause, and play control 210 that a user may select to control playback of the video clip 108.

The video capture user interface 202 can also display frames 212 of the video clip 108, as well as marked video segments 122 of the video clip that are each identified by a video segment selector 214. Although the video segment selectors 214 are shown in this example as borders around the selected frames (or around multiple frames) of the respective marked video segments 122, the video segment selectors may be displayed as any other type of visual indication of a marked video segment, such as a displayed line under or over the frames of a marked video segment.

Each of the display frames 212 may represent more than one video frame of the video clip 108 that is being displayed for viewing. The display frames 212 may also be displayed as thumbnail images, and a single thumbnail image can represent an entire video clip, a video segment of the video clip, multiple frames of the video clip, or a single frame of the video clip. The video capture user interface 202 also includes a video playback position indicator 216 that indicates the relative display position of the video clip, and indicates where in the video clip the user is viewing the video.

In implementations, a user can initiate to delete a marked video segment 122, such as with a double tap selection on a video segment selector 214. The video service 112 is implemented to receive the double tap input on the display and initiate deletion of the selected marked video segment, such as by displaying a delete confirmation that the user can select to confirm deletion of the selected marked video segment. A user may also initiate a swipe gesture on the integrated display device 110 (e.g., a touchscreen display) of the mobile phone 104, and the video service 112 initiates rewinding or fast-forwarding the video clip 108 that is being played back for review based on the direction of the swipe gesture across a touchscreen display. For example, the user can swipe the touchscreen display towards the right to fast-forward or otherwise advance the video clip, and the user can swipe the touchscreen display towards the left to rewind the video clip.

FIG. 3 illustrates an example 300 of a video select user interface 302 in embodiments of mobile device video selection and edit. The video select user interface 302 is displayed on an integrated display device 304 of a mobile device 306, such as a tablet device, and is shown larger at 308. The tablet device 306 is an example of the mobile device 102 described with reference to FIG. 1. The video select user interface 302 includes portions 310 of multiple, different video clips 108 with the marked video segments 122 identified by video segment selectors 312. Although the video segment selectors 312 are shown in this example as borders around the selected frames (or around multiple frames) of the respective marked video segments 122, the video segment selectors may be displayed as any other type of visual indication of a marked video segment.

The portions 310 of the video clips 108 are sequences of video frames of the respective video clips, and can be represented by x number of frames per second. For example, more frames of a short duration video clip may be displayed in the video select user interface than for a long duration video clip, given the space to display the portions of the video clips. Further, each of the different portions of the video clips may be displayed as a different x number of frames per second. Each of the frames of the marked video segments 122 may represent more than one video frame of a video clip, and the frames may also be displayed as thumbnail images, where a single thumbnail image can represent a single or multiple frames of the video clip.

Additionally, the portions 310 of the different video clips 108 are shown as being displayed together in the same video select user interface 302, and the portions of the video clips are displayed in a grid format that provides a visual overview of each respective video clip. Although only four portions of video clips are shown in this example, more or fewer video clips may be displayed, such as additional portions of the video clips that a user can scroll down to see on the display.

In implementations, a user can increase or decrease the length of a marked video segment 122 by selecting either end of a video segment selector 312 and dragging the selector to include more or less of the video frames in the marked video segment. The video service 112 is implemented to receive a segment selector input to a video segment selector 312, such as a user touch input on the display that is initiated to increase or decrease the length of a marked video segment 122. The video service can then modify the length of the marked video segment 122 by adding or reducing the number of frames of the marked video segment.

In this example, the video select user interface 302 includes a display representation of the shareable video compilation 126, which is generated by the video service 112 from the various, different marked video segments 122 of the video clips 108. For example, the shareable video compilation 126 is shown as four video frames or images, each corresponding to one of the respective marked video segments displayed in the video select user interface. The first video frame of the shareable video compilation 126 corresponds to the marked video segment of the dog running with trees in the background. The next video frame of the shareable video compilation corresponds to the marked video segment of the tree, the next video frame corresponds to the marked video segment of the dog running in a different direction, and the last video frame corresponds to the marked video segment of the scuba diver. A user can then share all of the marked video segments 122 of the shareable video compilation 126 together as one video. Although the marked video segments 122 of the shareable video compilation 126 are each shown or represented in this example as a single image or frame of the respective marked video segments, any number of images or frames of each of the marked video segments can be shown as part of the shareable video compilation in the video select user interface. Further, each of the images or frames of the respective marked video segments can represent a single or multiple frames of a marked video segment.

FIG. 4 illustrates an example 400 of a video arrange user interface 402 in embodiments of mobile device video selection and edit. The video arrange user interface 402 is shown displayed on the integrated display device 110 of the mobile phone 104, and shown larger at 404. The video arrange user interface 402 includes a list view 406 of the marked video segments 122 and a display representation of the shareable video compilation 126, as also described with reference to the video select user interface 302 shown in FIG. 3. The list view 406 of the marked video segments 122 can include the video segments from each of the different video clips, as generally shown with reference to the examples described herein. Alternatively, some of the marked video segments 122 may be from the same video clip. For example, the first (or top) marked video segment in the list view 406 of the dog running with the trees in the background may be from the same video clip as the second marked video segment showing just the tree. Alternatively or in addition, the third marked video segment of the dog running without any trees in the background may be from the same video clip as the first and/or the second marked video segments.

In implementations, a user can select to playback a marked video segment 122, such as with a user touch input to select a playback control 408 (e.g., a video play button) that corresponds to a respective marked video segment. In this example, the selected marked video segment is identified by a video segment selector 410, which a user can select either end of on the touchscreen to increase or decrease the length of the marked video segment by dragging the selector to include more or less video frames in the marked video segment. The video arrange user interface 402 also includes a position indicator 412 that indicates the relative display position of the marked video segment that is selected for playback with the playback control 408. For example, the position indicator 412 indicates the relative display position of the marked video segment in the video clip of the tree.

In this example, the list view 406 of the marked video segments 122 are displayed as a vertical list representation of the selected video segments ordered based on time of recording of the respective video clips. However, a user can also select a list view control 414, such as with a user touch input on the display, to reorder the list view 406 of the marked video segments 122. For example, a user can select and drag a list view control 414 to move a corresponding marked video segment, such as when the user reorders the marked video segments to change the order of video playback for the shareable video compilation 126. The video service 112 is implemented to reorder the playback order of the marked video segments 122 in the shareable video compilation 126 when a user initiates a video arrangement input by selecting a list view control 414 to reorder the list view 406 of the marked video segments.

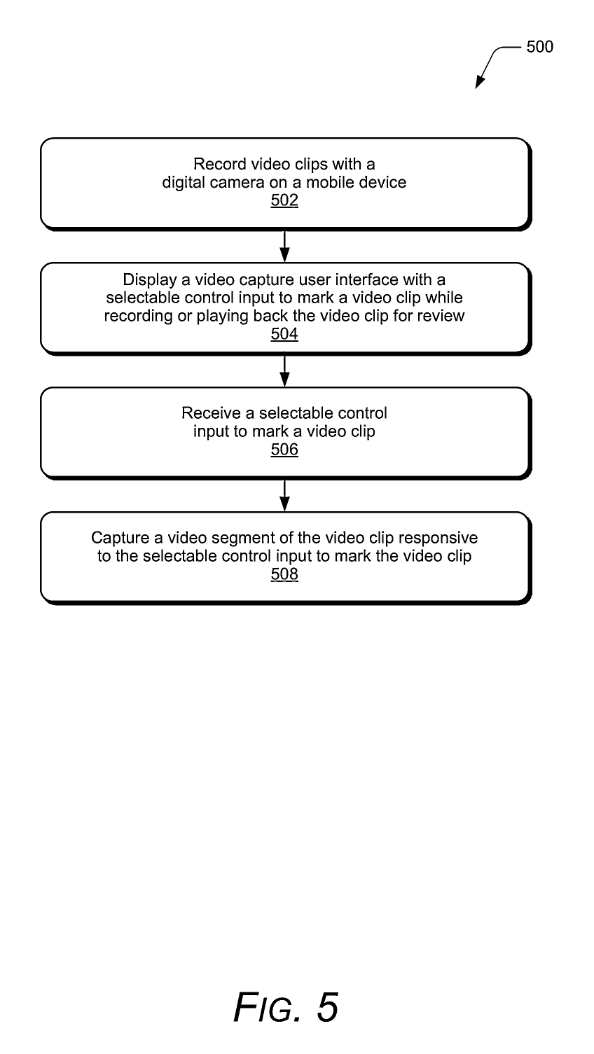

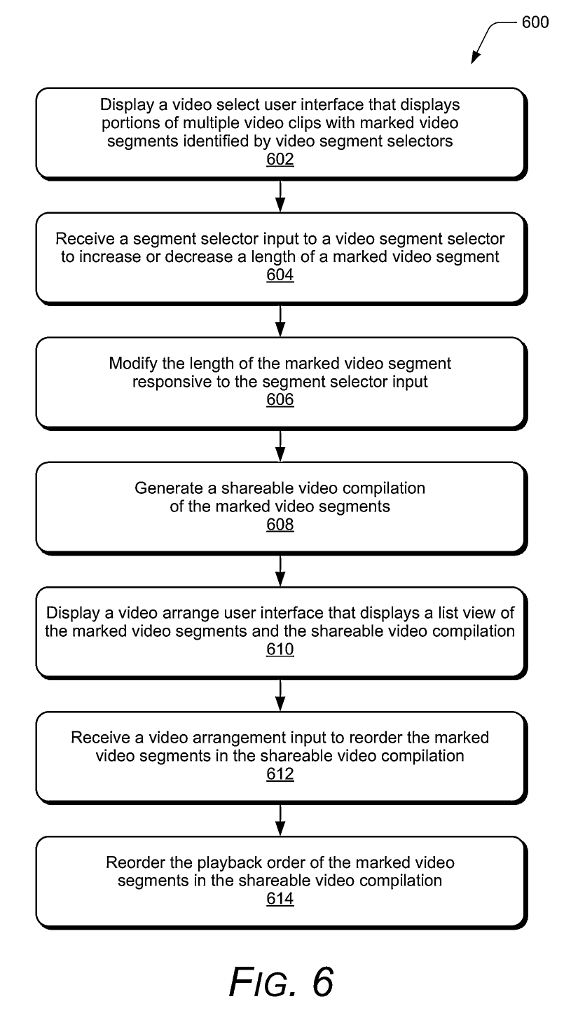

Example methods 500 and 600 are described with reference to respective FIGS. 5 and 6 in accordance with one or more embodiments of mobile device video selection and edit. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 5 illustrates example method(s) 500 of mobile device video selection and edit, and is generally described with reference to a video service implemented on a mobile device. The order in which the method is described is not intended to be construed as a limitation, and any number or combination of the method operations can be combined in any order to implement a method, or an alternate method.

At 502, video clips are recorded with a digital camera on a mobile device. For example, the mobile device 102 (FIG. 1), such as the mobile phone 104, a camera device, the tablet device 306, or any other electronic media device includes the digital camera 106 that records the video clips 108, such as when a user of the mobile device uses the digital camera to record video.

At 504, a video capture user interface is displayed with a selectable control input to mark a video clip while recording or playing back the video clip for review. For example, the video capture user interface 116 is displayed on the integrated display device 110 of the mobile phone 104, such as when a user is recording a video clip 108, and the video capture user interface 116 includes the selectable control 120 that the user can select to mark the video clip while recording the video clip. Similarly, the video capture user interface 202 is displayed on the integrated display device 110 of the mobile phone 104, such as when a user is playing back a video clip 108 for review, and the video capture user interface 202 includes the selectable control 206 that the user can select to mark the video clip while playing back the video clip.

At 506, a selectable control input is received to mark a video clip. For example, the video service 112 receives an input to the selectable control 120 on the video capture user interface 116, such as when a user marks a video clip 108 while recording the video clip. Similarly, the video service 112 receives an input to the selectable control 206 on the video capture user interface 202, such as when a user marks a video clip 108 while playing back the video clip for review. In implementations, a selectable control input is received to mark a start frame of a video segment of a video clip, and an additional input of the selectable control is received to mark an end frame of the video segment of the video clip. Alternatively, a user input of the selectable control 120 is received to mark a frame of a video segment of a video clip, as well as additional frames before and/or after the marked video frame 124 that are included as part of a marked video segment 122. Alternatively, the selectable control input is received as a press-and-hold input, where a start frame of the video segment of the video clip is marked corresponding to the press input, and an end frame of the video segment is marked responsive to the press-and-hold input being released.

At 508, a video segment of the video clip is captured responsive to the selectable control input to mark the video clip. For example, the video service 112 captures and identifies a marked video segment 122 of a video clip 108 when a user marks the video clip while recording the video clip, or while playing back the video clip for review (as described at 506).

FIG. 6 illustrates example method(s) 600 of mobile device video selection and edit, and is generally described with reference to a video service implemented on a mobile device. The order in which the method is described is not intended to be construed as a limitation, and any number or combination of the method operations can be combined in any order to implement a method, or an alternate method.

At 602, a video select user interface is displayed that includes portions of multiple video clips with marked video segments identified by video segment selectors. For example, the video select user interface 302 (FIG. 3) is displayed on the integrated display device 304 of the tablet device 306 (e.g., an example of the mobile device 102 described with reference to FIG. 1), and the video select user interface includes portions 310 of multiple, different video clips 108 with the marked video segments 122 identified by the video segment selectors 312. The portions 310 of the different video clips are displayed together in the same video select user interface, and the portions of the video clips are displayed in a grid format that provides a visual overview of each respective video clip.

At 604, a segment selector input to a video segment selector is received to increase or decrease a length of a marked video segment. For example, the video service 112 receives a segment selector input to a video segment selector 312, such as when a user initiates to increase or decrease the length of a marked video segment 122 by adding or reducing the number of frames of the marked video segment. At 606, the length of the marked video segment is modified responsive to the segment selector input. For example, the video service 112 modifies the length of the marked video segment 122 responsive to the segment selector input to the video segment selector 312 when initiated by the user (as described at 604).

At 608, a shareable video compilation of the marked video segments is generated. For example, the video service 112 generates the shareable video compilation 126 from the marked video segments 122 of the video clips 108. The shareable video compilation 126 can be generated from several different marked video segments 122, and then shared with other users, such as when communicated or distributed to other devices that are associated with the other users.

At 610, a video arrange user interface is displayed that includes a list view of the marked video segments and the shareable video compilation. For example, the video arrange user interface 402 (FIG. 4) is displayed on the integrated display device 110 of the mobile phone 104, and the video arrange user interface includes the list view 406 of the marked video segments 112, as well as a display of the shareable video compilation 126.

At 612, a video arrangement input is received to reorder the marked video segments in the shareable video compilation. For example, the video service 112 receives a video arrangement input to reorder the list view 406 of the marked video segments 122, such as when a user reorders the marked video segments to change the order of the shareable video compilation 126. At 614, the playback order of the marked video segments in the shareable video compilation are reordered responsive to the video arrangement input. For example, the video service 112 reorders the playback order of the marked video segments 122 in the shareable video compilation 126 responsive to the video arrangement input to reorder the list view 1406 of the marked video segments 122 when initiated by the user (as described at 612).

FIG. 7 illustrates an example system 700 that includes an example device 702, which can implement embodiments of mobile device video selection and edit. The example device 702 can be implemented as any of the devices described with reference to the previous FIGS. 1-6, such as any type of client device, mobile phone, tablet, computing, communication, entertainment, gaming, media playback, and/or other type of device. For example, the mobile device 102, the mobile phone 104, and the tablet device 306 shown in FIGS. 1-4 may be implemented as the example device 702.

The device 702 includes communication devices 704 that enable wired and/or wireless communication of device data 706, such as video clips and shareable video compilations stored on the device. The device data can include any type of audio, video, and/or image data, as well as recorded and communicated data. The communication devices 704 can also include transceivers for cellular phone communication and/or for network data communication.

The device 702 also includes input/output (I/O) interfaces 708, such as data network interfaces that provide connection and/or communication links between the device, data networks, and other devices. The I/O interfaces can be used to couple the device to any type of components, peripherals, and/or accessory devices, such as a digital camera device that may be integrated with device 702. The I/O interfaces also include data input ports via which any type of data, media content, and/or inputs can be received, such as user inputs to the device, as well as any type of audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage media 712, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 712 provides storage of the device data 706 and various device applications 714, such as an operating system that is maintained as a software application with the computer-readable storage media and executed by the processing system 710. In this example, the device applications also include a video service 716 that implements embodiments of mobile device video selection and edit, such as when the example device 702 is implemented as the mobile device 102 or the mobile phone 104 shown in FIG. 1, or as the tablet device 306 shown in FIG. 3. An example of the video service 716 is the video service 112 implemented at the mobile device 102, as described with reference to FIG. 1.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device.

In embodiments, at least part of the techniques described for mobile device video selection and edit may be implemented in a distributed system, such as over a “cloud” 724 in a platform 726. The cloud 724 includes and/or is representative of the platform 726 for services 728 and/or resources 730. For example, the services 728 and/or resources 730 may include the video service 716, or distributed components of the video service.

The platform 726 abstracts underlying functionality of hardware, such as server devices (e.g., included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device embodiment with functionality distributed throughout the system 700. For example, the functionality may be implemented in part at the example device 702 as well as via the platform 726 that abstracts the functionality of the cloud 724.

Although embodiments of mobile device video selection and edit have been described in language specific to features and/or methods, the appended claims are not necessarily limited to the specific features or methods described. Rather, the specific features and methods are disclosed as example implementations of mobile device video selection and edit.

1. A mobile device, computing:
an integrated digital camera configured to record video clips;
a display device configured to display a video capture user interface that displays the video clips, the video capture user interface including a selectable control to mark a video clip; and
a processing system to implement a video service configured to:
receive an input of the selectable control;
mark a frame of the video clip that correlates to the input while the video clip is being recorded; and
mark a video segment of the video clip, the video segment including at least a start frame and an end frame after the marked frame, the video clip being displayable as a marked video segment independent from the video clip.

2. A mobile device as recited in claim 1, wherein the video service is configured to mark the video segment of the video clip responsive to the input, the video segment including the marked frame of the video clip and one or more additional frames of the video clip between the start frame and the end frame.

3. A mobile device as recited in claim 1, wherein the marked frame of the video clip is the start frame of the video segment of the video clip, and the video service is configured to:
receive an additional input of the selectable control; and
mark the end frame of the video segment of the video clip.

4. A mobile device as recited in claim 1, wherein the video service is configured to:
receive the input of the selectable control as a press and hold input of the selectable control;
mark the frame of the video clip as the start frame of the video segment of the video clip; and
mark the end frame of the video segment of the video clip responsive to the press and hold input being released.

5. A mobile device as recited in claim 1, wherein the video service is configured to receive a segment selector input to a video segment selector to increase or decrease a length of a marked video segment as identified by the video segment selector.

6. A mobile device as recited in claim 1, wherein the display device is configured to display a video select user interface that displays portions of the video clips with marked video segments identified by video segment selectors.

7. A mobile device as recited in claim 6, wherein the display device is configured to display the portions of different video clips in the same display.

8. A mobile device as recited in claim 6, wherein the display device is configured to display the portion of a video clip in a grid format that provides a visual overview of the video clip.

9. A mobile device as recited in claim 1, wherein the display device is configured to display a video arrange user interface that displays a list view of marked video segments and a shareable video compilation of the marked video segments.

10. A method, comprising:
recording video clips with a digital camera on a mobile device;
receiving a selectable control input to mark a video clip while said recording the video clip; and
capturing a video segment of the video clip responsive to the selectable control input to mark the video clip, the video segment including at least a start frame and an end frame of the video segment, the video segment being displayable independent from the video clip that is said recording.

11. A method as recited in claim 10, further comprising:
said receiving the selectable control input to mark the start frame of the video segment of the video clip;
receiving an additional input of the selectable control to mark the end frame of the video segment of the video clip.

12. A method as recited in claim 10, further comprising:
said receiving the selectable control input to mark the video clip as a press and hold input;
marking the start frame of the video segment of the video clip responsive to the press and hold input being initiated; and
marking the end frame of the video segment of the video clip responsive to the press and hold input being released.

13. A method as recited in claim 10, further comprising:
displaying a video capture user interface that includes the selectable control input to mark the video clip while one of playing back the video clip for review or said recording the video clip.

14. A method as recited in claim 10, further comprising:
displaying a video select user interface that displays portions of the video clips with marked video segments identified by video segment selectors.

15. A method as recited in claim 14, further comprising:
receiving a segment selector input to a video segment selector to increase or decrease a length of a marked video segment as identified by the video segment selector; and
modifying the length of the marked video segment responsive to the segment selector input.

16. A method as recited in claim 14, further comprising:
generating a shareable video compilation of the marked video segments.

17. A method as recited in claim 10, further comprising:
displaying a video arrange user interface that displays a list view of marked video segments and a shareable video compilation of the marked video segments; and
receiving a video arrangement input to reorder the marked video segments in the shareable video compilation.

18. Computer-readable storage media comprising a video service stored as instructions that are executable and, responsive to execution of the instructions at a computing device, the computing device performs operations of the video service comprising to:
receive a selectable control input to mark a video clip while the video clip is being recorded;
mark at least a start frame of the video clip responsive to the selectable control input;
initiate a video capture user interface for display that includes the selectable control input to further mark the video clip while playing back the video clip for review; and
capture a video segment of the video clip, the video segment including the start frame of the video clip and one or more additional frames of the video clip.

19. Computer-readable storage media as recited in claim 18, wherein the computing device performs the operations of the video service further comprising to:
initiate a video select user interface that displays portions of multiple video clips with marked video segments identified by video segment selectors;
modify the length of a marked video segment of a video clip to increase or decrease a length of the marked video segment.

20. Computer-readable storage media as recited in claim 19, wherein the computing device performs the operations of the video service further comprising to:
generate a shareable video compilation of the marked video segments; and
initiate a video arrange user interface that displays a list view the marked video segments and the shareable video compilation of the marked video segments.
